(19) United States
(12) Patent Application Publication
(10) Pub. No.: US 2023/0120806 A1
(43) Pub. Date: Apr. 20, 2023

(54) CONVOLUTION OPERATION METHOD

(71) Applicant: SigmaStar Technology Ltd., Xiamen (CN)

(72) Inventor: Yong-Sheng CHEN, Shanghai (CN)

(21) Appl. No.: 17/858,449

(22) Filed: Jul. 6, 2022

(30) Foreign Application Priority Data
Oct. 14, 2021 (CN) 202111198116.7

(51) Int. Cl. G06F 12/02; G06F 17/15

(52) U.S. Cl. CPC G06F 12/023; G06F 17/15; G06F 2212/7204

(57) ABSTRACT

A convolution operation method includes: configuring an operation apparatus according to a partition rule; reading an operation data partition; reading a depthwise convolution parameter partition to perform a depthwise weighting operation to generate a depthwise weighted partition; performing a depthwise offset operation to generate a depthwise convolution operation result partition; reading a pointwise convolution parameter partition to perform a pointwise weighting operation on the depthwise convolution operation result partition to generate a pointwise weighted partition, and performing an accumulation process in a depth dimension to generate an output partition; when the output partition meets operation criteria in the depth dimension, performing a pointwise offset operation on the output partition to generate and output a pointwise convolution operation result partition; and when the output partition does not meet the operation criteria in the depth dimension, configuring the output partition to be a previous output partition to operate next operation data.

This application claims the benefit of China application Serial No. CN 202111198116.7, filed Oct. 14, 2021, the subject matter of which is incorporated herein by reference.

### BACKGROUND OF THE INVENTION

### Field of the Invention

The disclosure relates to a convolution operation technique, and more particularly, to a convolution operation method.

### Description of the Related Art

Convolution operations are extensively applied in signal and image processing as well as other engineering and scientific fields. One of the most crucial applications in the recent years is convolutional neural networks in deep learning.

The depthwise separable convolution operation is one means for performing a convolution operation, and involves an operation approach of separating the convolution operation into two part - a depthwise convolution operation and a pointwise convolution operation, and performing the two. In the prior art, a depthwise convolution operation is first performed, and a result of the depthwise convolution operation is stored in a dynamic random access memory (DRAM), from which the result of the depthwise convolution operation is fetched to a memory (usually a static random access memory (SRAM)) when a pointwise convolution operation is to be performed. Considering hardware restrictions such as the capacity of a memory and transmission bandwidths between different memories, as the amount of data required for the depthwise convolution and the pointwise convolution becomes large, transfers of such massive data between memories can likely cause degradation of convolution operation speed and performance.

### SUMMARY OF THE INVENTION

In view of the issues of the prior art, it is an object of the disclosure to provide a convolution operation method so as to improve the prior art.

The disclosure provides a convolution operation method applied to an operation apparatus. The convolution operation method includes: (A) configuring the operation apparatus to prompt the operation apparatus to access, according to a partition rule, operation data, a set of depthwise convolution parameters and a set of pointwise convolution parameters stored in an external memory; (B) reading and storing an operation data partition from the external memory to an internal memory; (C) reading and storing a corresponding depthwise convolution parameter partition from the external memory to the internal memory, and performing a depthwise weighting operation on the operation data partition by a convolution operation circuit to generate a depthwise weighted partition; (D) performing a depthwise offset operation on the depthwise weighted partition by the convolution operation circuit to generate a depthwise convolution operation result partition; (E) reading and storing a corresponding pointwise convolution parameter partition from the external memory to the internal memory, and performing a pointwise weighting operation on the depthwise convolution operation result partition by the convolution operation circuit to generate a pointwise weighted partition, and performing an accumulation process in a depth dimension on the pointwise weighted partition to generate an output partition, wherein the accumulation process accumulates the pointwise weighted partition and a previous output partition when the previous output partition exists; (F) when the output partition meets operation criteria in the depth dimension, performing a pointwise offset operation on the output partition by the convolution operation circuit to accordingly generate, output and store a pointwise convolution operation result partition to the external memory; when the output partition does not meet the operation criteria in the depth dimension, configuring the output partition to be the previous output partition, and performing step (B) to step (F) on a next operation data partition; and (G) performing step (B) to step (F) until the operation data is completely operated.

The disclosure further provides a convolution operation method applied to an operation apparatus. The operation apparatus includes an internal memory, a convolution operation circuit and a direct memory access (DMA) circuit. The convolution operation method includes: storing an operation data partition of operation data and a corresponding depthwise convolution parameter partition of a set of depthwise convolution parameters from an external memory to the internal memory by the DMA circuit according to a partition rule; performing a depthwise convolution operation on the operation data partition and the depthwise convolution parameter partition by the convolution operation circuit to generate a depthwise convolution operation result partition; storing a corresponding pointwise convolution parameter partition in a set of pointwise convolution parameters from the external memory to the internal memory by the DMA circuit according to the partition rule; performing a pointwise convolution operation on the depthwise convolution operation result partition and the pointwise convolution parameter partition by the convolution operation circuit to generate a pointwise convolution operation result partition; and storing the pointwise convolution operation result partition to the external memory by the DMA circuit. The depthwise convolution operation result partition is not stored to the external memory.

In the convolution operation method of the disclosure, data access and operation are performed by means of a partitioned operation mechanism, and a pointwise convolution operation is subsequently performed without storing a result of the depthwise convolution operation to the external memory. Therefore, data transmissions between the internal memory and the external memory are reduced and convolution operation efficiency is significantly enhanced.

Features, implementations and effects of the disclosure are described in detail in preferred embodiments with the accompanying drawings below.

### BRIEF DESCRIPTION OF THE DRAWINGS

FIG. 1 is a block diagram of an operation apparatus with a partitioned operation mechanism and an external memory according to an embodiment of the disclosure;

FIG. 2A is a schematic diagram of a depthwise convolution operation according to an embodiment of the disclosure;

FIG. 2B is a schematic diagram of a pointwise convolution operation according to an embodiment of the disclosure;

FIG. 3 is a flowchart of a convolution operation method with a partitioned operation mechanism according to an embodiment of the disclosure;

FIG. 4A is a schematic diagram of a depthwise convolution operation according to an embodiment of the disclosure;

FIG. 4B is a schematic diagram of a pointwise convolution operation according to an embodiment of the disclosure;

FIG. 5A is a schematic diagram of stored contents of an internal memory corresponding to a depthwise convolution operation according to an embodiment of the disclosure; and

FIG. 5B is a schematic diagram of stored contents of an internal memory corresponding to a pointwise convolution operation according to an embodiment of the disclosure.

### DETAILED DESCRIPTION OF THE INVENTION

It is an object of the disclosure to provide a convolution operation method and apparatus with a partitioned operation mechanism for partitioning and operating convolution data and parameters, so as to reduce data transmissions between an internal memory and an external memory and to significantly enhance convolution operation efficiency.

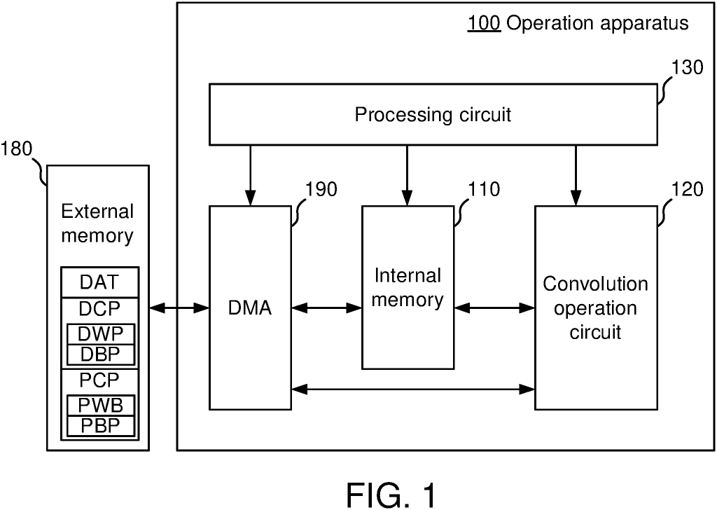

Refer to FIG. 1. FIG. 1 shows a block diagram of an operation apparatus 100 with a partitioned operation mechanism and an external memory 180 according to an embodiment of the disclosure. The operation apparatus 100 reads data stored in the external memory 180 to perform a convolution operation, and includes an internal memory 110, a convolution operation circuit 120, a direct access memory (DMA) circuit 190 and a processing circuit 130.

In one embodiment, the internal memory 110, the convolution operation circuit 120, the DMA circuit 190 and the processing circuit 130 may be integrated on a same chip die, and the external memory 180 is arranged on another chip die. The processing circuit 130 is electrically coupled to the internal memory 110, the DMA circuit 190 and the convolution operation circuit 120, so as to control operations of the DMA circuit 190, the internal memory 110 and the convolution operation circuit 120, and to perform the convolution operation method to achieve the object of performing the convolution operation method.

Under control of the processing circuit 130, the DMA circuit 190 reads, partition by partition, operation data DAT, a set of depthwise convolution parameters DCP and a set of pointwise convolution parameters PCP stored in the external memory 180 to the internal memory 110 or the convolution operation circuit 120 for a convolution operation. In one embodiment, the internal memory 110 is a static random access memory (SRAM), and the external memory 180 is a dynamic random access memory (DRAM).

The convolution operation circuit 120 includes a plurality of multiplyaccumulate circuits (not shown) to perform multiplication and accumulation operations needed for the convolution operation. Under control of the processing circuit 130, the convolution operation circuit 120 reads data partitions and parameter partitions needed for operations from the internal memory 110 or the external memory 180, performs a depthwise convolution operation and a pointwise convolution operation, and outputs final operation results to the external memory 180 for storage.

The depthwise convolution operation and the pointwise convolution operation are described below.

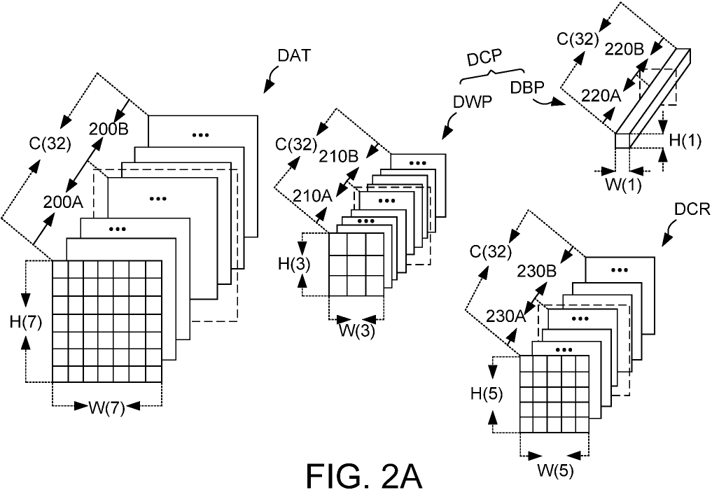

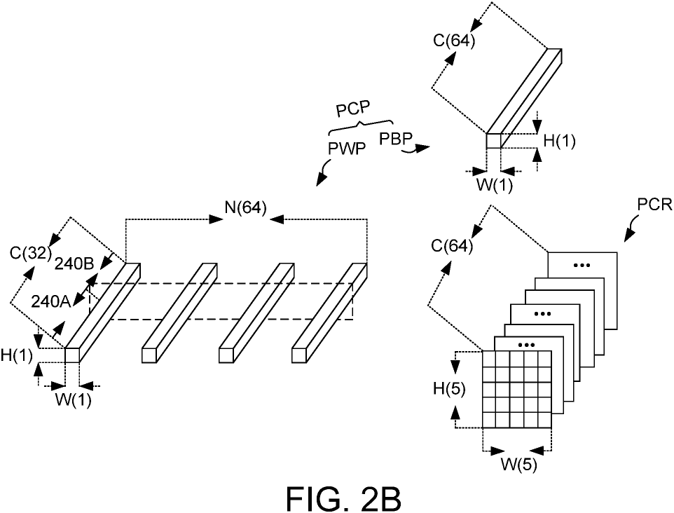

Refer to FIG. 2A and FIG. 2B. FIG. 2A shows a schematic diagram of a depthwise convolution operation according to an embodiment of the disclosure. FIG. 2B shows a schematic diagram of a pointwise convolution operation according to an embodiment of the disclosure.

As shown in FIG. 2A, the depthwise convolution operation is performed according to the operation data DAT and a set of depthwise convolution parameters DCP so as to generate a depthwise convolution operation result DCR. In one embodiment, a set of depthwise convolution parameters DCP includes a set of depthwise convolution weights DWP for performing a depthwise weighting operation and a set of depthwise convolution offsets DBP for performing a depthwise offset operation.

Each of the operation data DAT, the depthwise convolution weights DWP and the depthwise convolution offsets DBP includes a width dimension W, a height dimension H and a depth dimension C. FIG. 2A depicts exemplary dimension values, wherein dimensions of the operation data DAT are 7×7×32, and dimensions of the depthwise convolution weights DWP are 3×3×32. The depthwise convolution offsets DBP are a one-dimensional vector, and have 1×1×32 dimensions.

In the depthwise weighting operation, an operation is performed in the depth dimension C on the 32 depthwise convolution weights DWP and the 32 operation data in one-on-one correspondence, so as to generate 32 operation results in the depth dimension C. Without considering redundant data outside boundaries, regarding each of the operation result in the depth dimension C, a 3×3 depthwise convolution weight DWP is used as a mask that is moved by one point at a time in the horizontal and vertical directions on the 7×7 operation data DAT, and an operation is performed on each covered region (for example, the points are multiplied, added and then averaged) to generate a 5×5 operation result.

In the depthwise offset operation, 32 operation results in the depth dimension C are added with values of the depthwise convolution offsets DPB in one-on-one correspondence (for example, the points in the operation result in the width dimension W and the height dimension H are individually added with the value of one depthwise convolution offset DPB) to generate a depthwise convolution operation result DCR in 5×5×32 dimensions.

It should be noted that the depthwise convolution operation described above serves as merely an example. In other embodiments, redundant data padded outside boundaries of the operation data DAT may also be considered for the operation; alternatively, the mask formed by the depthwise convolution weights DWP may also be moved by two points at a time in the horizontal and vertical directions, and each covered region is then used for the operation. The disclosure is not limited to a specific operation approach.

The pointwise convolution operation is performed according to the depthwise convolution operation result DCR in FIG. 2A and the pointwise convolution parameters DCP in FIG. 2B, so as to generate a pointwise convolution operation result PCR in FIG. 2B. In one embodiment, a set of pointwise convolution parameters PCP includes a set of pointwise convolution weights PWP for performing a pointwise weighting operation and a set of pointwise convolution offsets PBP for performing a pointwise offset operation.

Each of the pointwise convolution weights PWP and the pointwise convolution offsets PBP includes a width dimension W, a height dimension H and a depth dimension C, and the pointwise convolution weights PWP further includes a number dimension N corresponding to the depth dimension C of the pointwise convolution offsets PBP. FIG. 2B depicts exemplary dimension values, wherein dimensions of the pointwise convolution weights PWP are 1×1×32×64. The pointwise convolution offsets PBP are a one-dimensional vector, and have 1×1×64 dimensions.

In the pointwise weighting operation, an operation is performed in the depth dimension C on 32 1×1 pointwise convolution weight units in each 1×1×32 pointwise convolution weight PWP and 32 depthwise convolution operation results DCR in one-on-one correspondence (for example, multiplied) to generate one single total operation result having 5×5 dimensions generated by adding and averaging 32 operation results in 5×5 dimensions. The operation above is performed in the number dimension N on each of the 64 pointwise convolution weights PWP and the depthwise convolution operation result DCR to generate 64 total operation results in 5×5 dimensions.

In the pointwise offset operation, the total operation results and the 64 pointwise convolution offsets PBP in the depth dimension C are added in one-on-one correspondence to generate a pointwise convolution operation result PCR in 5×5×64 dimensions.

In order to reduce back-and-forth data transmissions between the internal memory 110 and the external memory 180 so as to achieve the object of accelerating the convolution operation, the operation apparatus 100 performs the convolution operation method by means of a partitioned operation mechanism, such that the pointwise convolution operation is subsequently performed without storing the result of the depthwise convolution operation to the external memory 180. The partitioned operation mechanism is further described in detail below.

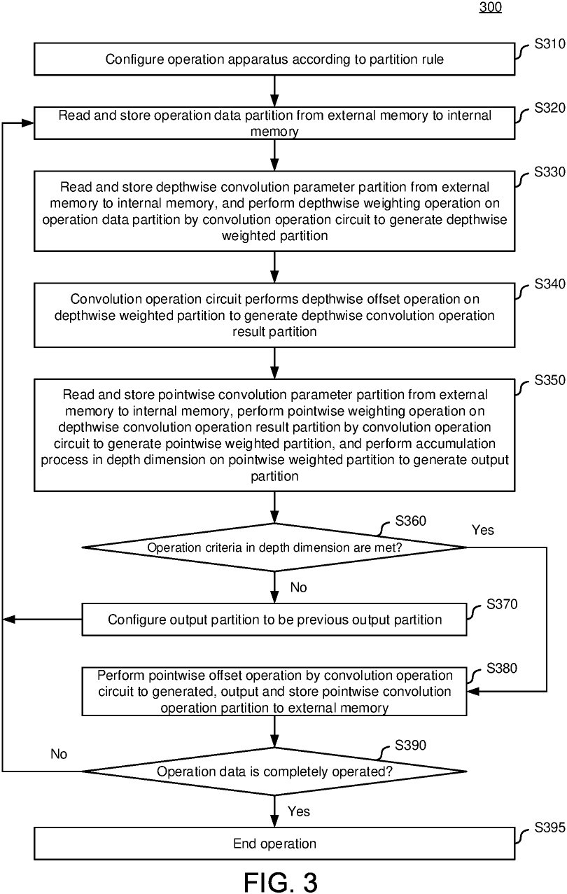

Refer to FIG. 3. FIG. 3 shows a flowchart of a convolution operation method 300 with a partitioned operation mechanism according to an embodiment of the disclosure. The convolution operation method 300 may be applied to, for example but not limited to, the operation apparatus 100 in FIG. 1. According to an embodiment, the convolution operation method 300 includes the following steps, as shown in FIG. 3.

In step S310, the operation apparatus 100 is configured to prompt the operation apparatus 100 to access, according to a partition rule, data including the operation data DAT, the depthwise convolution parameters DCP and the pointwise convolution parameters PCP stored in the external memory 180.

In one embodiment, the processing circuit 130 of the operation apparatus 100 is configured according to a predetermined partition rule, and controls, according to this partition rule, the DMA circuit 190, the internal memory 110 and/or the convolution operation circuit 120 to read partition data including the operation data DAT, the depthwise convolution parameters DCP and the pointwise convolution parameters PCP from the external memory 180, so as to perform the convolution operation.

The partition rule above describes the partition approach performed on the operation data DAT, the depthwise convolution parameters DCP and the pointwise convolution parameters PCP according to at least one dimension. In one embodiment, after being configured according to the predetermined partition rule, the processing circuit 130 may generate an access control instruction conforming to the partition rule to control the DMA circuit 190 to access the data including the operation data DAT, the depthwise convolution parameters DCP and the pointwise convolution parameters PCP stored in the external memory 180.

After partitioning, the operation data DAT is partitioned into multiple operation data partitions, the depthwise convolution parameters DCP are partitioned into multiple depthwise convolution parameter partitions, and the pointwise convolution parameters PCP are partitioned into multiple pointwise convolution parameter partitions.

Implementation details of the process of the convolution operation method 300 are described first for a situation where the operation data DAT is partitioned only according to the depth dimension C to generate a specific number of operation data partitions.

The depthwise convolution weights DWP and the depthwise convolution offsets DBP included in the depthwise convolution parameters DCP are partitioned according to the depth dimension C. The depthwise convolution parameter partitions generated include the predetermined number of depthwise convolution weight partitions and depthwise convolution offset partitions. An operation performed according to the depthwise convolution parameters DCP includes a depthwise weighting operation and a depthwise offset operation.

The pointwise convolution weights PWP included in the pointwise convolution parameters PCP are partitioned according to the depth dimension C, and the pointwise convolution offsets PBP included in the pointwise convolution parameters PCP are not partitioned in this embodiment. The pointwise convolution parameter partitions generated include the predetermined number of pointwise convolution weight partitions and the pointwise convolution offsets PBP. An operation performed according to the pointwise convolution parameters PCP includes a pointwise weighting operation and a pointwise offset operation.

Taking FIG. 2A for example, the operation data DAT is partitioned to generate operation data partitions 200A and 200B both in 7×7×16 dimensions. The depthwise convolution weights DWP and the depthwise convolution offsets DPB are partitioned to respectively generate depthwise convolution weight partitions 201A and 210B both in 3×3×16 dimensions and depthwise convolution offset partitions 220A and 220B both in 1×1×16 dimensions. The depthwise convolution operation result DCR is also partitioned into depthwise convolution operation result partitions 230A and 230B both in 5×5×16 dimensions.

The pointwise convolution weights PWP are partitioned to generate pointwise convolution weight partitions 240A and 240B both in 1×1×16×64 dimensions. Since the depth dimension C of the pointwise convolution offsets PBP corresponds to the number dimension N of the pointwise convolution weights PWP, when the pointwise convolution weights PWP are not partitioned in the number dimension N, the pointwise convolution offsets PBP do not need to be partitioned and are kept in the 1×1×64 dimensions.

In step S320, the operation data partitions are read and stored from the external memory 180 to the internal memory 110. In this embodiment, the operation data partition 200A is first read and stored to the internal memory 110.

In step S330, a corresponding depthwise convolution parameter partition is read and stored from the external memory 180 to the internal memory 110, and the convolution operation circuit 120 accordingly performs a depthwise weighting operation on the operation data partition to generate a depthwise weighted partition.

In step S340, the convolution operation circuit 120 performs a depthwise offset operation on the depthwise weighted partition to generate a depthwise convolution operation result partition.

In this embodiment, the depthwise convolution weight partition 210A and the depthwise convolution offset partition 220A corresponding to the operation data partition 200A are read. After performing a depthwise weighting operation on the operation data partition 200A according to the depthwise convolution weight partition 210A to generate a depthwise weighted partition (not shown), the convolution operation circuit 120 performs a depthwise offset operation on the depthwise weighted partition according to the depthwise convolution offset partition 220A to generate the depthwise convolution operation result partition 230A in 5×5×16 dimensions.

In step S350, a corresponding pointwise convolution parameter partition is read and stored from the external memory 180 to the internal memory 110, and the convolution operation circuit 120 accordingly performs a pointwise weighting operation on the depthwise convolution operation result partition to generate a pointwise weighted partition, and performs an accumulation process in the depth dimension on the pointwise weighted partition to generate an output partition. The accumulation process accumulates the pointwise weighted partition and a previous output partition when the previous output partition exists.

In this embodiment, the pointwise convolution weight partition 240A and the pointwise convolution offsets PBP are read. The convolution operation circuit 120 performs a pointwise weighting operation on the depthwise convolution operation result partition 230A according to the pointwise convolution weight partition 240A in 1×1×16×64 dimensions to generate a pointwise weighted partition (not shown) in 5×5×64 dimensions.

Since the operation data partitions are generated according to the depth dimension C, the pointwise convolution weights PWP having a dimension of 32 in the depth dimension C are also partitioned in the depth dimension C. More specifically, each of the pointwise convolution weight partition 240A and the pointwise convolution weight partition 240B having a dimension of 16 in the depth dimension C need to be accumulated with the pointwise weighted partition generated by the operation on the depthwise convolution operation result partition 230A, in order to restore an operation result having a dimension of 32 in the depth dimension C.

Thus, when the operation data partition is generated according to the depth dimension C, a previous output partition is configured and initialized to 0. The accumulation process accumulates the pointwise weighted partition and the previous output partition when the previous output partition exists so as to generate an output partition (not shown).

In step S360, it is determined whether the output partition meets operation criteria in the depth dimension.

In one embodiment, when the operation data DAT is not partitioned according to the depth dimension, or when the operation data DAT is partitioned according to the depth dimension and the accumulation process in the depth dimension is completely performed for the output partition, the output partition is said to have met the operation criteria in the depth dimension.

The output partition generated according to the pointwise convolution weight partition 240A does not meet the operation criteria in the depth dimension.

In step S370, the output partition is configured to the previous output partition, and step S320 to step S360 are performed on the next operation data partition 200B.

Thus, the process returns to step S320 to read the operation data partition 200B, and in steps S330 and S340, the corresponding depthwise convolution weight partition 210B and depthwise convolution offset partition 220B are read, and the convolution operation circuit 120 performs the depthwise weighting operation and the depthwise offset operation to generate the depthwise convolution operation result partition 230B in 5x5x16 dimensions. Next, in step 350 of the process, the pointwise convolution weight partition 240B is read (the pointwise convolution offsets PBP have been read, and is selectively not additionally read), and the pointwise weighting operation is performed on the depthwise convolution operation result partition 230B to generate a pointwise weighted partition in 5x5x64 dimensions, further generating an output partition by means of accumulation with the previous output partition by the accumulation process. At this point, in step S360, it is determined whether the accumulation in the depth dimension is completely performed for the output partition, and whether the operation criteria in the depth dimension are met.

In step S380, when the output partition meets the operation criteria, the convolution operation circuit 120 accordingly performs a pointwise offset operation on the output partition to generate a pointwise convolution operation result partition, which is output to the internal memory 110 or is stored to the external memory 180 via the DMA circuit 190.

Thus, the convolution operation circuit 120 performs the pointwise offset operation on the output partition according to the pointwise convolution offsets PBP, and generates the pointwise convolution operation result partition, which is output to the internal memory 110 or is stored to the external memory 180 via the DMA circuit 190. In this embodiment, the pointwise convolution operation result partition is equivalent to the pointwise convolution operation result PCR in FIG. 2B.

In step S390, it is determined whether the operation data is completely operated.

In this embodiment, the operation is completely performed on the operation data partitions 200A and 200B generated from partitioning the operation data and ends accordingly, and thus the process proceeds to step S395 to end the operation.

On the other hand, when the partition rule is performing partitioning on the operation data DAT according to only one of the width dimension W and the height dimension H of the operation data DAT, the operation is substantially the same due to irrelevancy with the depth dimension. Implementation details of the process of the convolution operation method 300 are described for a situation where the operation data DAT is partitioned only according to the width dimension W to generate a specific number of operation data partitions.

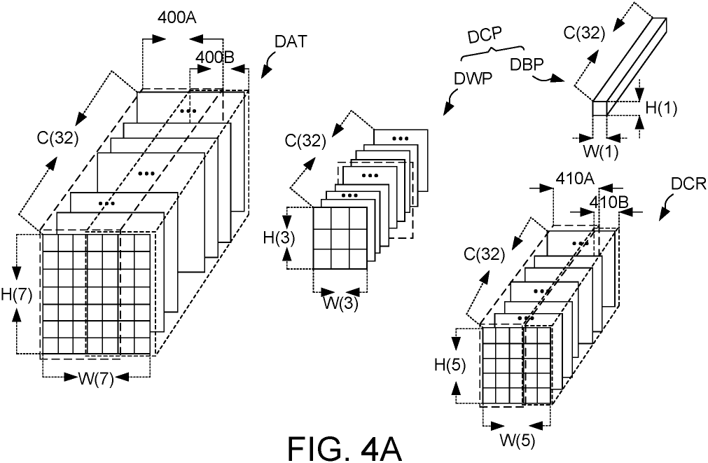

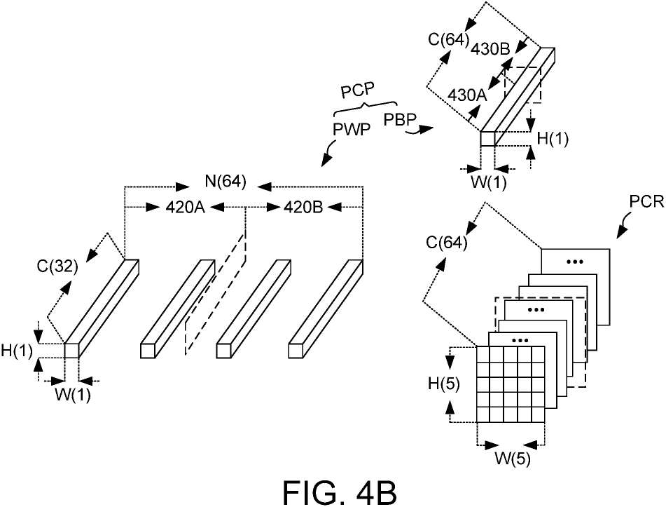

Refer to FIG. 4A and FIG. 4B. FIG. 4A shows a schematic diagram of a depthwise convolution operation according to an embodiment of the disclosure. FIG. 4B shows a schematic diagram of a pointwise convolution operation according to an embodiment of the disclosure. The data and parameters shown in FIG. 4A and FIG. 4B are the same as those in FIG. 2A and FIG. 2B. Such associated details are omitted herein.

In the embodiment in FIG. 4A and FIG. 4B, the partition rule is partitioning according to the width dimension W of the operation data DAT to generate predetermined number of operation data partitions, wherein an overlapping region is present between adjacent operation partitions and dimensions of the overlapping region are determined by the dimensions of the depthwise convolution weights DWP and the weighting operation method. The depthwise convolution weights DWP and the depthwise convolution offsets DBP included in the depthwise convolution parameters DCP are not partitioned. Thus, the depthwise convolution parameter partitions include the depthwise convolution weights DWP and the depthwise convolution offsets DBP.

The pointwise convolution weights PWP included in the pointwise convolution parameters PCP are selectively partitioned according to the number dimension to generate a predetermined number of pointwise convolution weight partitions. The pointwise convolution offsets PBP are selectively partitioned according to the depth dimension to generate a predetermined number of pointwise convolution offset partitions.

It should be noted that, the partitioning of the pointwise convolution parameters PCP is in fact independent from the partitioning of the operation data DAT according to the width dimension W, and so it can be determined whether to selectively partition the pointwise convolution parameters PCP according to requirements.

Taking FIG. 4A for example, the operation data DAT is partitioned to generate operation data partitions 400A and 400B respectively in 5×7×16 dimensions and 4×7×16 dimensions. Because the dimensions of the depthwise convolution weights DWP are 3×3×32, and the weighting operation is performed by using the depthwise convolution weights DWP as a mask that is moved by one point each time in the horizontal and vertical directions, an overlapping region between the operation data partitions 400A and 400B is 2×7×16.

The depthwise convolution weight DWP and the depthwise convolution offset DBP, which do not need to be partitioned, are kept in 3×3×32 and 1×1×32 dimensions. The depthwise convolution operation result DCR is partitioned into depthwise convolution operation result partitions 410A and 410B respectively in 3×5×32 and 2×5×32 dimensions.

In this embodiment, the pointwise convolution weights PWP are partitioned according to the number dimension to generate two pointwise convolution weighted partitions 420A and 420B both in 1×1×32×32 dimensions. The pointwise convolution offsets PBP are partitioned according to the depth dimension to generate two pointwise convolution offset partitions 430A and 430B both in 1×1×32 dimensions.

The convolution operation method 300 performed according to the partitioning approach in FIG. 4A and FIG. 4B is described below. In the process, the operation data partition 400A is read in step S320, and in steps S330 and S340, the corresponding depthwise convolution weights DWP and the depthwise convolution offsets DBP are read and the convolution operation circuit 120 performs the depthwise weighting operation and the depthwise offset operation to generate the depthwise convolution operation result partition 410A in 3×5×32 dimensions. Next, in step S350 of the process, the pointwise convolution weight partitions 420A and 420B as well as the pointwise convolution offset partitions 430A and 430B are read, and the pointwise weighting operation is performed on the depthwise convolution operation result partition 410A to generate a pointwise weighted partition (not shown) in 3×5×32 dimensions.

When operation data DAT is partitioned according to the depth dimension, the previous output partition is non-existent. The accumulation process has the pointwise weighted partition be directly output as the output partition (not shown).

At this point, in step S360, since the operation data DAT is not partitioned and generated according to the depth dimension, it is determined that the output partition meets operation criteria in the depth dimension. In step S380 of the process, the convolution operation circuit 120 accordingly performs a pointwise offset operation on the output partition to generate, output and store a pointwise convolution operation result partition in 3×5×32 dimensions to the external memory 180.

It should be noted that, the pointwise convolution weight partitions 420A and 420B as well as the pointwise convolution offset partitions 430A and 430B are respectively two partitions. Thus, in practice, an operation may be first be performed on the pointwise convolution weight partition 420A and the pointwise convolution offset partition 430A and the corresponding depthwise convolution operation result partition 410A to generate one output partition, and the pointwise offset operation is then performed to output one pointwise convolution operation result partition. Then, an operation is performed on the pointwise convolution weighted partition 420B and the pointwise convolution offset partition 430B and the corresponding depthwise convolution operation result partition 410A to generate another output partition, and the pointwise offset operation is performed to output another pointwise convolution operation result partition.

In step S390, it is determined whether the operation data is completely operated.

In this embodiment, the operation data partition 400B is not completely operated, and so the process proceeds to step S320 to step S360 for the next operation data partition 400B. Without accumulation in the depth dimension, the operation process of the operation data partition 400B is the same as that of the operation data partition 400A, two 2×5×32 pointwise convolution operation result partitions are generated, output and stored to the external memory 180 in step S380, and the associated details are omitted herein. Next, in step S390 of the process, it is determined both the operation data partitions 400A and 400B generated by partitioning the operation data are completely operated, and the operation ends in step S395.

The embodiments above are described by taking partitioning the operation data according to only the depth dimension C and only according to the width dimension W. However, according to requirements, the partition rule for the operation data may be determined according to various arrangements and combinations of the width dimension W, the height dimension H and the depth dimension C.

It should be noted that, to prevent arbitrary partitioning from causing unsatisfactory operation efficiency, a preferred partition rule needs to satisfy the following conditions: (1) the numbers of the operation data partitions and the depthwise convolution weighted partitions, and the depthwise convolution operation result partitions and the pointwise convolution weights are equal in the depth dimension; (2) the numbers of the depthwise convolution offset partitions and the operation data partitions are equal in the depth dimension; and (3) the numbers of the pointwise convolution operation result partitions and the pointwise convolution offsets are equal in the depth dimension.

In practice, the partitioning approach for data and parameters (including dimensions and size) may be determined according to the storage capacity of the internal memory 110. The internal memory 110 corresponds to the depthwise convolution operation and the pointwise convolution operation, which respectively contain contents that are necessarily stored.

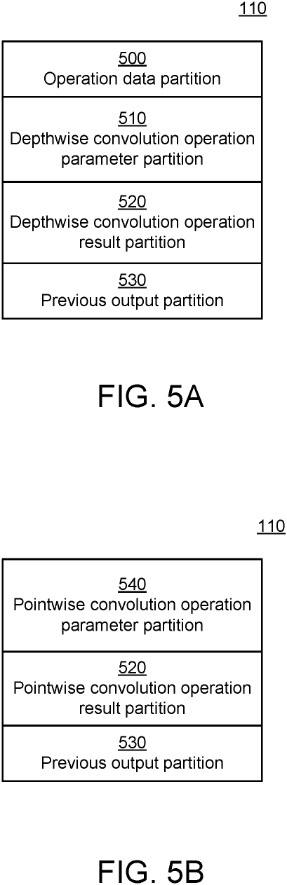

Refer to FIG. 5A and FIG. 5B. FIG. 5A shows a schematic diagram of stored contents of the internal memory 110 corresponding to the depthwise convolution operation according to an embodiment of the disclosure. FIG. 5B shows a schematic diagram of stored contents of the internal memory 110 corresponding to the pointwise convolution operation according to an embodiment of the disclosure.

As shown in FIG. 5A, the storage capacity of the internal memory 110 corresponds to the depthwise convolution operation, and needs to at least store an operation data partition 500, a depthwise convolution parameter partition 510 and a depthwise convolution operation result partition 520, and further needs to store a previous output partition 530 generated by a pointwise convolution operation when the operation data partition 500 is generated by partitioning the operation data at least according to the depth dimension.

As shown in FIG. 5B, the storage capacity of the internal memory 110 corresponds to the pointwise convolution operation, and at least needs to be sufficient to store the depthwise convolution operation result partition 520, a pointwise convolution parameter partition 540 and the previous output partition 530.

An area occupied by the operation data partition 500, the depthwise convolution parameter partition 510 and the depthwise convolution operation result partition 520 and an area occupied by the pointwise convolution parameter partition 540 in the pointwise convolution operation may be a temporally substitutable common area. That is, the operation data partition 500, the depthwise convolution parameter partition 510, the depthwise convolution operation result partition 520 and the pointwise convolution parameter partition 540 can use a first area included in the internal memory 110 in a time-division multiplexed manner. The depthwise convolution operation result partition 520 may be shared it serves as output data in the depthwise convolution operation and serves as input data in the pointwise convolution operation.

The previous output partition 530 generated by the pointwise convolution operation needs to be accumulated with the convolution operation results of different operation data partitions, and hence cannot share a storage space with other data; that is, a second area included in the internal memory 110 is exclusive to the previous output partition 530.

Therefore, the partitioning approach for data and parameters needs to be carried out according to the contents necessarily stored in the internal memory 110 above.

In other embodiments, transmission bandwidths of the external memory 180 and the internal memory, a utilization rate of data, a utilization rate of the depthwise convolution operation and a utilization rate of the pointwise convolution operation can all be used as factors in the consideration of the partitioning approach for the operation data.

Thus, with the partitioned operation mechanism above, the convolution operation method and apparatus of the disclosure only need to read required data partitions and parameter partitions from the external memory 180 to the internal memory 110 when the convolution operation is performed, and output the same to the external memory 180 once the operation is completely performed. As a result, the amount of data transmissions between the internal memory 110 and the external memory 180 can be greatly reduced.

It should be noted that the embodiments above serve as merely examples. In other embodiments, modifications may be made by a person skilled in the art without departing from the spirit of the disclosure. It should be understood that the steps described in the embodiments above, unless the orders are otherwise specified, may have orders adjusted according to actual requirements, or the steps may all or partially be performed simultaneously.

In the convolution operation method and apparatus of the disclosure, data and parameters used for convolution are partitioned and operated, and more particularly, a pointwise convolution operation is subsequently performed without storing a result of the depthwise convolution operation to the external memory. Therefore, data transmissions between the internal memory and the external memory are reduced and convolution operation efficiency is significantly enhanced.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. A convolution operation method, applied to an operation apparatus, comprising:
(A) configuring the operation apparatus to prompt the operation apparatus to access, according to a partition rule, operation data, a set of depthwise convolution parameters and a set of pointwise convolution parameters stored in an external memory;
(B) reading and storing an operation data partition from the external memory to an internal memory;
(C) reading and storing a corresponding depthwise convolution parameter partition of the set of depthwise convolution parameters from the external memory to the internal memory, and accordingly performing a depthwise weighting operation on the operation data partition by a convolution operation circuit to generate a depthwise weighted partition;
(D) performing a depthwise offset operation on the depthwise weighted partition by the convolution operation circuit to generate a depthwise convolution operation result partition;
(E) reading and storing a corresponding pointwise convolution parameter partition of the set of pointwise convolution parameters from the external memory to the internal memory, accordingly performing a pointwise weighting operation on the depthwise convolution operation result partition by the convolution operation circuit to generate a pointwise weighted partition, and performing an accumulation process in a depth dimension on the pointwise weighted partition to generate an output partition, wherein the accumulation process accumulates the pointwise weighted partition and a previous output partition when the previous output partition exists;
(F) when the output partition meets a depthwise dimension operation criterion, performing a pointwise offset operation on the output partition by the convolution operation circuit to generate a pointwise convolution operation result partition to be stored to the external memory; when the depth dimension operation criterion is not met, configuring the output partition to be the previous output partition, and performing step S(B) to step (F) on a next operation data partition; and
(G) performing step (B) to step (F) on the next operation data partition until the operation data is completely operated.

2. The convolution operation method of claim 1, wherein
the set of depthwise convolution parameters includes a set of depthwise convolution weights and a set of depthwise convolution offsets, and the set of pointwise convolution parameters includes a set of pointwise convolution weights and a set of pointwise convolution offsets;
each of the operation data, the set of depthwise convolution weights, the set of depthwise convolution offsets, the set of pointwise convolution weights, the set of pointwise convolution offsets has a width dimension, a height dimension and the depth dimension, and the set of pointwise convolution weights further includes a number dimension and corresponds to the depth dimension of the set of pointwise convolution offsets; and
when the operation data is not partitioned according to the depth dimension, or when the operation data is partitioned according to the depth dimension and the accumulation process in the depth dimension is completely performed for the output partition, the output partition is said to have met the operation criterion in the depth dimension.

3. The convolution operation method of claim 2, wherein
when the operation data is partitioned according to one of the width dimension and the height dimension to generate a predetermined number of the operation data partitions, an overlapping region is present between adjacent operation data partitions, and dimensions of the overlapping region are determined by a weighting operation method.

4. The convolution operation method of claim 2, wherein
the internal memory has a storage capacity corresponding to the depthwise convolution operation, at least stores the operation data partition, the depthwise convolution parameter partition and the depthwise convolution operation result partition, and stores the previous output partition when the operation data partition is generated by partitioning the operation data at least according to the depth dimension.

5. The convolution operation method of claim 1, wherein the internal memory is a static random access memory (SRAM), the external memory is a dynamic random access memory (DRAM), and the internal memory and the external memory transmit data in between through a direct memory access (DMA) circuit.

6. A convolution operation method, applied to an operation apparatus, the operation apparatus comprising an internal memory, a convolution operation circuit and a direct memory access (DMA) circuit; the method comprising:
storing an operation data partition of operation data and a corresponding depthwise convolution parameter partition in a set of depthwise convolution parameters from an external memory to the internal memory by the DMA circuit according to a partition rule;
performing a depthwise convolution operation on the operation data partition and the depthwise convolution parameter partition by the convolution operation circuit to generate a depthwise convolution operation result partition;
storing a corresponding pointwise convolution parameter partition in a set of pointwise convolution parameters from the external memory to the internal memory by the DMA circuit according to the partition rule;
performing a pointwise convolution operation on the depthwise convolution operation result partition and the pointwise convolution parameter partition by the convolution operation circuit to generate a pointwise convolution operation result partition; and
storing the pointwise convolution operation result partition to the external memory by the DMA circuit;
wherein, the depthwise convolution operation result partition is not stored to the external memory.

7. The convolution operation method of claim 6, wherein the internal memory comprises a first area and a second area, the first area is time-division multiplexed for the operation data partition, the depthwise convolution parameter partition, the depthwise convolution operation result partition and the pointwise convolution parameter partition, and the second area is exclusive to output data of the pointwise convolution operation.

8. The convolution operation method of claim 6, wherein the operation apparatus further comprises a processing circuit, the method further comprising:
configuring, according to the partition rule, the processing circuit to control the DMA circuit to read the operation data, the set of depthwise convolution parameters and the set of pointwise convolution parameters stored in the external memory.

9. The convolution operation method of claim 6, wherein the partition rule is determined by a storage capacity of the internal memory.
